(19) United States
(12) Patent Application Publication
(10) Pub. No.: US 2022/0156639 A1
(43) Pub. Date: May 19, 2022

(54) PREDICTING PROCESSING WORKLOADS

(71) Applicant: Hewlett-Packard Development Company, L.P., Spring, TX (US)

(72) Inventors: Vitor Henrique da Silva, Porto Alegre (BR); Thomas da Silva Paula, Porto Alegre (BR); Pedro Henrique Garcez Monteiro, Porto Alegre (BR)

(73) Assignee: Hewlett-Packard Development Company, L.P., Spring, TX (US)

(21) Appl. No.: 17/414,416

(22) PCT Filed: Aug. 7, 2019
(86) PCT No.: PCT/US19/45577

§ 371 Date: Jun. 16, 2021

(51) Int. Cl. G06N 20/00; G06F 9/50

(52) U.S. Cl. CPC G06N 20/00; G06F 9/505

(57) ABSTRACT

Examples of methods for predicting processing workloads are described herein. In some examples, a method may include predicting a processing workload for a set of machine learning models. In some examples, the method may include loading a machine learning model of the set of machine learning models from non-volatile memory based on the predicted processing workload.

### BACKGROUND

The use of electronic devices has expanded. Computing devices are a kind of electronic device that includes electronic circuitry for performing processing. As processing capabilities have expanded, computing devices have been utilized to perform more functions. For example, a variety of computing devices are used for work, communication, and entertainment. Computing devices may be linked to a network to facilitate communication between computing devices.

### BRIEF DESCRIPTION OF THE DRAWINGS

FIG. 1 is a flow diagram illustrating an example of a method for predicting processing workload;

FIG. 2 is a flow diagram illustrating an example of a method for predicting processing workloads;

FIG. 3 is a block diagram of an example of an apparatus that may be used in predicting processing workloads; and

FIG. 4 is a block diagram illustrating an example of a computer-readable medium for predicting processing workloads.

### DETAILED DESCRIPTION

Machine learning is a technique where a machine learning model is trained to perform a task based on a set of examples (e.g., data). In some examples, executing machine learning models may be computationally demanding for processors, such as central processing units (CPUs). Deploying machine learning models can be challenging in the context of providing machine learning models as a service.

In some approaches, processors may perpetually maintain machine learning models in random access memory (RAM) to keep machine learning models ready to use, which may enable a service to quickly respond to clients. For example, machine learning models may be perpetually maintained in RAM to provide machine learning models through representational state transfer (REST) application programming interfaces (APIs) due to high loading times. However, perpetually maintaining machine learning models in RAM may come with increased cost and/or energy consumption. This may be due to expensive and/or power-hungry hardware, such as graphics processing units (GPUs). For example, maintaining machine learning models on GPUs may consume increased resources. A GPU is hardware (e.g., circuitry) that performs arithmetic calculations. For example, a GPU may perform calculations related to graphics processing and/or rendering.

In some approaches, machine learning models may be loaded on demand (e.g., a machine learning model is loaded when a client requests). One issue with loading machine learning models on demand is that loading times may be high depending on the model. For example, some convolutional neural networks may utilize increased loading times. This may affect service availability and/or the client may experience undesirable delay in the service.

Some examples of the techniques described herein may allow machine learning models to be loaded in anticipation of a client request (e.g., before inferences are requested via an API), using a director mechanism to determine whether and/or when machine learning models should be loaded. In some examples, the director mechanism may be based on a machine learning model (e.g., predictive model(s), neural network(s), etc.). In some examples, a set of machine learning models may be stored in memory (e.g., non-volatile memory (NVM), solid state drives, flash memory, etc.). Some examples of NVM may provide relatively high transfer speeds and/or low loading times. For instance, some examples of NVM may include dual in-line memory modules (DIMMs) (e.g., persistent DIMMS, non-volatile DIMMs), solid state drives (SSDs), flash memory, etc. Storing the machine learning models in some kinds of memory (e.g., some kinds of NVM) may reduce loading time while reducing processor usage, which may reduce energy consumption and/or cost. For example, the machine learning models may be stored in memory while not in use. In some examples, the NVM may provide access speed that is slower (e.g., 5× slower, 8× slower, 9× slower, 10× slower, etc.) than RAM.

In some examples, the director mechanism may enable efficiently handling requests and/or triggering loading/unloading of resources. This may result in a more efficient use of processors and memory. For example, some of the techniques described herein may reduce loading time for machine learning models and/or may reduce the usage of resources by using a machine learning model. In some examples, the machine learning model may be trained to learn the workload of the processors. In some examples, the machine learning model may provide organized API processing execution with NVM loading approaches that may reduce load time for a CPU.

Some examples of the techniques described herein may avoid perpetually maintaining machine learning models running in processing resources (e.g., CPU, GPU, and/or tensor processing unit (TPU)). For example, the director mechanism may predict when to load machine learning models and/or which processing resource(s) to use. Some examples of the techniques described herein may utilize NVM to reduce loading time of the machine learning models, which may enable increased service availability and/or may reduce service delay.

In some examples of the techniques described herein, a set of machine learning models may be pre-trained for provision as a service. Some examples of the techniques described herein may enable balancing processing workload by providing a director mechanism to load a machine learning model or models from NVM. For instance, the director mechanism may be based on a machine learning model to predict processing workload, which may be utilized to load a machine learning model before receiving a client request.

Throughout the drawings, identical reference numbers may designate similar, but not necessarily identical, elements. Similar numbers may indicate similar elements. When an element is referred to without a reference number, this may refer to the element generally, without necessary limitation to any particular drawing figure. The drawing figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

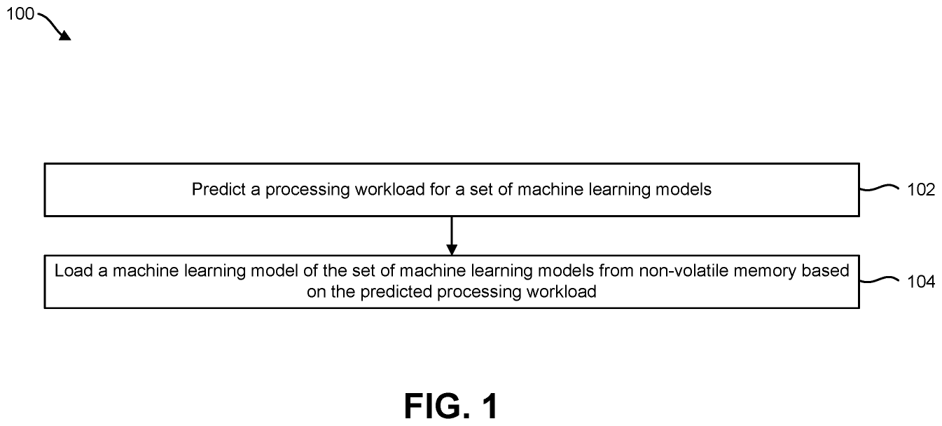

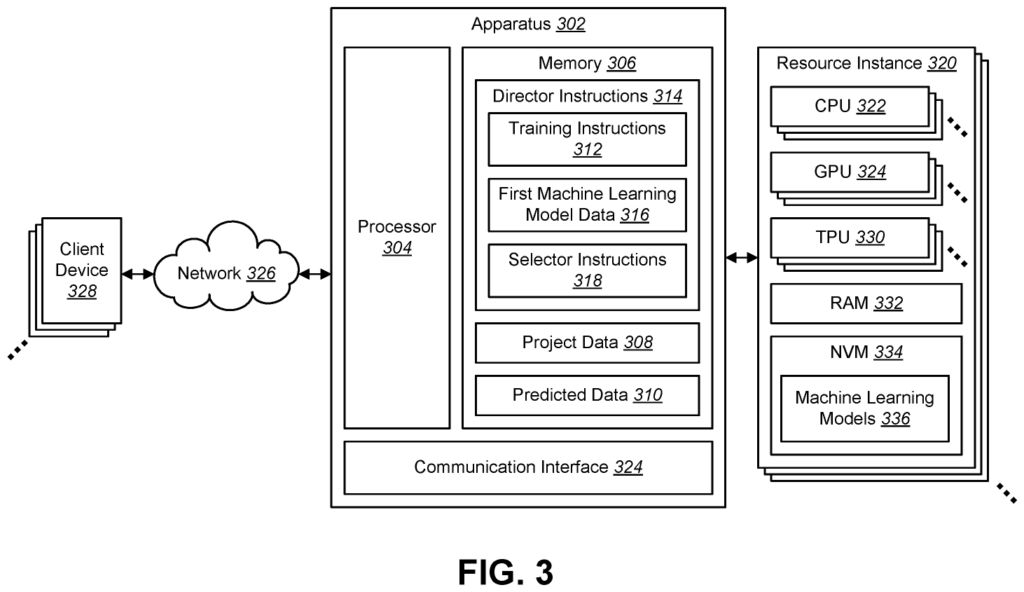

FIG. 1 is a flow diagram illustrating an example of a method 100 for predicting processing workload. The method 100 and/or a method 100 element or elements may be performed by an apparatus (e.g., electronic device, computing device, server, etc.). For example, the method 100 may be performed by the apparatus 302 described in connection with FIG. 3.

The apparatus may predict 102 a processing workload for a set of machine learning models. A processing workload is an amount of processing for a project. A project is a computational task performed on a set of data. Examples of projects may include classification, object detection, regression, clustering, etc., performed on a set of data. For instance, examples of projects may include performing object detection in a set of digital images, object recognition in a set of digital images, speech recognition in digital audio data, classifying spam emails in a set of email data, etc. In some examples, a processing workload may be quantified as a percentage of processing resources used to process a project. For example, an image classification project may have a processing workload of 10% of a GPU.

A machine learning model is a structure that learns based on training. For example, a machine learning model may be trained with a data set to perform prediction, classification, object detection, regression, clustering, etc. Examples of machine learning models may include artificial neural networks, support vector machines, decision trees, etc. A set of machine learning models may include different machine learning models that may be utilized for different types of projects. For instance, one machine learning model may be utilized to perform image classification and another machine learning model may be utilized to perform object detection.

Predicting 102 the processing workload for the set of machine learning models may include predicting a processing workload for a machine learning model or machine learning models of the set of machine learning models to perform a project. For example, a machine learning model may consume 20% of the processing resources of a tensor processing unit (TPU) to perform image classification on a set of digital images. A TPU is hardware (e.g., circuitry) for processing linear algebra workloads. For example, a TPU may be utilized to process heavy linear algebra workloads.

The apparatus may load 104 a machine learning model of the set of machine learning models from non-volatile memory (NVM) based on the predicted processing workload. For example, loading 104 the machine learning model may include retrieving the machine learning model from non-volatile memory and storing the machine learning model in random access memory (RAM). In some examples, loading 104 the machine learning model may include sending a message to a resource instance to retrieve the machine learning model from NVM and store the machine learning model into RAM. In some examples, the predicted processing workload may be utilized to determine whether to load the machine learning model and/or to determine a processor type utilized. For instance, loading 104 the machine learning model based on the predicted processing workload may include determining whether the predicted processing workload is greater than a workload threshold. In some examples, if the predicted processing workload is greater than the workload threshold, the machine learning model may be loaded from NVM to RAM and/or may be loaded for a resource instance with a processor type (e.g., TPU). In some examples, if the predicted processing workload is less than or equal to (e.g., is not greater than) the workload threshold, the machine learning model may not be loaded or may be loaded for a resource instance with another processor type (e.g., CPU, GPU).

A resource instance is a combination of memory and processing resources. For example, a resource instance may include NVM, RAM, CPU resources, GPU resources, and/or TPU resources. In some examples, resource instances may be physical machines (e.g., computing devices, servers, etc.), virtual machines, and/or containers. In some examples, multiple resource instances may share a pool of NVM, RAM, CPU resources, GPU resources, and/or TPU resources. CPU resources, GPU resources, and/or TPU resources may be utilized to perform processing related to a machine learning model or machine learning models. In some examples, a resource instance or resource instances may be included in the apparatus. In some examples, resource instance(s) may be housed in separate computing devices (e.g., servers) that are in communication with the apparatus. For instance, an apparatus may load 104 a machine learning model from NVM into RAM within the apparatus and/or may load 104 a machine learning model by sending a message over a network to a computing device to cause the computing device to load a machine learning model from NVM into RAM on the computing device.

In some examples, the method 100 (or an operation or operations of the method 100) may be repeated over time. For example, predicting 102 a processing workload and/or loading 104 may machine learning model may be repeated periodically over time.

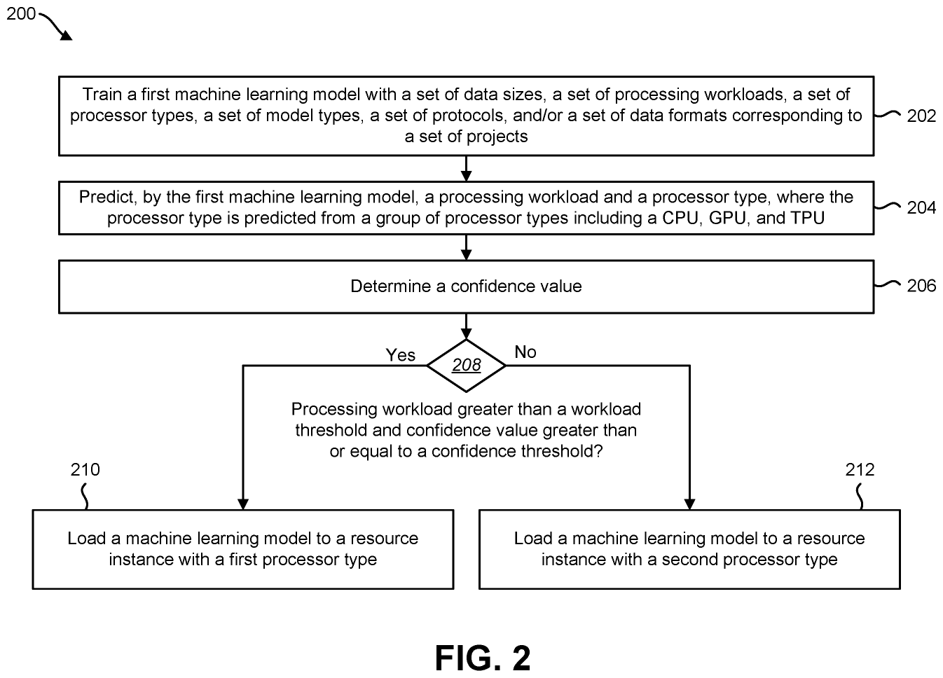

FIG. 2 is a flow diagram illustrating an example of a method 200 for predicting processing workloads. The method 200 and/or a method 200 element or elements may be performed by an apparatus (e.g., electronic device, computing device, server, etc.). For example, the method 200 may be performed by the apparatus 302 described in connection with FIG. 3. In some examples, the method 200 or element(s) thereof described in connection with FIG. 2 may be an example of the method 100 or element(s) thereof described in connection with FIG. 1.

In some examples, the apparatus may train 202 a first machine learning model with a set of data sizes, a set of processing workloads, a set of processor types, a set of model types, a set of protocols, a set of data formats, and/or a set of information (that characterizes a workload or type of work, for instance) corresponding to a set of projects. For example, the first machine learning model may be trained based on a set of projects that have been previously requested and/or completed. For instance, the apparatus may receive, measure, record, and/or store information associated with a project request and/or performance of a project. A project request is a message received from a client. In some examples, a project request may indicate a data size for a project, a model type or model types for a project, a protocol used to communicate the project request, and/or a data format of data for a project.

A data size is an amount of information for processing in a project. For example, a data size may indicate an amount of information of a file or set of files, image(s), audio, samples, etc., corresponding to a project. In some examples, a data size may be indicated by a project request. For example, a data size may be indicated by a project request received from a client. The data size may be stored in association with the project.

A processor type is a type of processor or processing resource. Examples of processor types include CPUs, GPUs, and TPUs. For training, a processor type may indicate a processor or processing resource that was used to perform a project. A processor type may indicate a single processor type (e.g., a CPU, GPU, or TPU) or multiple processor types (e.g., a combination of CPU(s), GPU(s), and/or TPU(s)). In some examples, a processor type may indicate a number of processors used to process a project (e.g., 1 CPU and 2 GPUs, 1 CPU and a TPU, etc.). In some examples, the processor type used for a project may be received and/or stored. For example, the apparatus may select a processor type(s) for a project based on a project parameter or parameters (e.g., model type, data size, protocol, data format, etc.). For instance, before the first machine learning model is trained, the apparatus may select the processor type(s) for a project requested by a client. In some examples, the apparatus may select the processor type(s) from a look-up table. For instance, the project parameter(s) may be utilized to look up the processor type(s). The processor type(s) for the project may be stored in association with the project.

As described above, a processing workload is an amount of processing for a project. For training, a processing workload may indicate an amount of processing performed for a project. For example, an amount of processing performed for a project may be measured, received, and/or stored in association with the project.

A model type is a type of machine learning model or models. In some examples, a model type may indicate a pre-trained machine learning model or models from a set of machine learning models (e.g., a predetermined set of machine learning models offered by a service). Examples of model types include classification models, detection models, regression models, clustering models, etc. For training, a model type may indicate the machine learning model(s) used to perform a project. A model type may indicate a single machine learning model or multiple machine learning models. In some examples, a model type may be indicated by a project request. For example, a model type or types may be indicated by a project request received from a client. The model type(s) may be stored in association with the project.

A protocol is a communication protocol or an indication of a protocol. For example, a protocol may be a communication protocol used to send and/or receive a project request. Examples of protocols include representational state transfer (REST), simple object access protocol (SOAP), and remote procedure call (RPC) (e.g., gRPC). Other protocols may be utilized. In some examples, a protocol may be indicated by a project request. For example, a protocol may be indicated by a project request received from a client. The protocol may be stored in association with the project.

A data format is a format for data of a project. For example, a data format may be a format in which data for a project is received. Examples of data formats include JavaScript object notation (JSON) and protocol buffers (protobuf). Other data formats may be utilized. In some examples, a data format may be indicated by a project request. For example, a data format may be indicated by a project request received from a client. The data format may be stored in association with the project.

In some examples, other data or information may be utilized to train 202 the first machine learning model. For example, project request times (e.g., time of day, date, etc.) may be utilized to train 202 the first machine learning model. In some examples, the data sizes, processing workloads, processor types, model types, protocols, and/or data formats may be omitted from data to train 202 the first machine learning model.

Training 202 the machine learning model may include adjusting a weight or weights of the machine learning model. In some examples, the machine learning model may be trained to predict a processing workload and/or a processor type. In some examples, the machine learning model may be trained to predict a time or times at which project requests may arrive and/or a time or times when demand occurs for a machine learning model or machine learning models. In some examples, predicting the processor type may correspond to the processing workload (e.g., processing amount) and/or may include predicting a processor type that offers improved efficiency and/or speed. For example, the machine learning model may be trained to predict a processor type that offers reduced power consumption, reduced resource consumption, and/or reduced processing time to complete a project. In some examples, the machine learning model may be trained with data from previously executed projects, such as power consumption, number of processors utilized, types of processors utilized, and/or processing time. The trained machine learning model may predict a processor type that offers reduced power consumption (e.g., a least amount of power consumption of available processor types), reduced resource consumption (e.g., the least number of processors utilized), and/or reduced processing time (e.g., the least length of processing time of available processor types). In some examples, the predicted processor type may correspond to the processing workload (e.g., amount of processing) and/or to an anticipated type of workload or project. For example, a TPU may be better suited to some linear algebra workloads (e.g., some kinds of image classification), a GPU may be suited to some kinds of image classification workloads, and/or a CPU may be suited to some kinds of object detection workloads.

The apparatus may predict 204 by the first machine learning model, a processing workload and a processor type. The processor type may be predicted from a group of processor types including CPU, GPU, and TPU. For example, the first machine learning model may be utilized to predict processing workload and processor type for an anticipated project or projects.

In some examples, the apparatus may determine 206 a confidence value. A confidence value is a value that indicates a confidence of a prediction. For example, the confidence value may accompany a prediction (e.g., processing workload prediction, processor type prediction, etc.) and may indicate a likelihood that the prediction is correct. In some examples, the first machine learning model may produce the confidence value. For example, the first machine learning model may determine the confidence value in association with the prediction 204 of the processing workload and/or processor type.

In some examples, the apparatus may determine 208 whether the processing workload is greater than a workload threshold and the confidence value is greater than or equal to a confidence threshold. For example, the apparatus may compare the predicted processing workload to a workload threshold (e.g., 70%) and may compare the confidence value to a confidence threshold (e.g., 0.9).

In a case that the processing workload is greater than the workload threshold and the confidence value is greater than or equal to the confidence threshold, the apparatus may load 210 a machine learning model to a resource instance with a first processor type. For example, the machine learning model may be loaded from NVM into RAM of a resource instance that includes the first processor type. For instance, the apparatus may load 210 the machine learning model to a resource instance with a CPU, GPU, or TPU.

In a case that the processing workload is not greater than a workload threshold or the confidence value is not greater than or equal to the confidence threshold, the apparatus may load 212 a machine learning model to a resource instance with a second processor type (e.g., a processor type different from the first processor type in some examples). For instance, the apparatus may load 212 the machine learning model to a resource instance with a CPU, GPU, and/or TPU.

Loading the machine learning model based on the predicted processing workload and/or the confidence value may provide benefits relating to resource consumption. For example, if the predicted processing workload is greater than the workload threshold and the confidence value is greater than or equal to the confidence threshold, the machine learning model may be loaded 210 with a first processor type. This may occur in cases where the processing workload is relatively large and where the prediction is relatively confident. This may be beneficial because resources may be expended in anticipation of a large workload that utilizes a particular processing type. Thus, when a large workload is requested, the machine learning model may already be loaded into RAM for processing the large workload, thereby reducing loading delay for a project or projects. In some examples, if the processing workload is less than or equal to the workload threshold or if the confidence value is less than the confidence threshold, the machine learning model 212 may be loaded to a resource instance with a second processor type that utilizes less resources. This may be beneficial in that fewer resources may be expended in anticipation of a project in a case that the processing workload is less or in a case that the prediction is less confident.

In some examples, the apparatus may load the machine learning model into RAM of a resource instance with a predicted processor type and with available processing resources that are greater than the predicted processing workload. For example, the apparatus may determine a resource instance that includes the predicted processor type (e.g., CPU, GPU, and/or TPU) and that also has available processing resources that are greater than the predicted processing workload.

FIG. 3 is a block diagram of an example of an apparatus 302 that may be used in predicting processing workloads. The apparatus 302 may be an electronic device, such as a personal computer, a server computer, a smartphone, a tablet computer, etc. The apparatus 302 may include and/or may be coupled to a processor 304 and/or a memory 306. The apparatus 302 may include additional components (not shown) and/or some of the components described herein may be removed and/or modified without departing from the scope of this disclosure.

The processor 304 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions stored in the memory 306. In some examples, the processor 304 may include an electronic circuit or circuits that include electronic components for performing a function or functions of the instructions. In some examples, the processor 304 may be implemented to perform one, some, or all of the functions, operations, elements, methods, etc., described in connection with one, some, or all of FIGS. 1-4.

The memory 306 may be any electronic, magnetic, optical, or other physical storage device that contains or stores electronic information (e.g., instructions and/or data). The memory 306 may be, for example, Random Access Memory (RAM), Electrically Erasable Programmable Read-Only Memory (EEPROM), a storage device, an optical disc, and/or the like. In some examples, the memory 306 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some implementations, the memory 306 may be a non-transitory tangible machine-readable storage medium, where the term “non-transitory” does not encompass transitory propagating signals. In some examples, the memory 306 may include multiple devices (e.g., a RAM card and a solid-state drive (SSD)).

In some examples, the apparatus 302 may include a communication interface 324 through which the processor 304 may communicate with an external device or devices (e.g., client device(s) 328 and/or resource instance(s) 320). In some examples, the apparatus 302 may be in communication with (e.g., coupled to, have a communication link with) a remote client device 328 or remote client devices 328 via a network 326. Examples of the client device(s) 328 may include computing devices, desktop computers, laptop computers, smart phones, tablet devices, game consoles, etc. Examples of the network 326 may include a local area network (LAN), wide area network (WAN), the Internet, cellular network, Long Term Evolution (LTE) network, etc.

The communication interface 324 may include hardware and/or machine-readable instructions to enable the processor 304 to communicate with the external device or devices. The communication interface 324 may enable a wired and/or wireless connection to the external device or devices. In some examples, the communication interface 324 may include a network interface card and/or may also include hardware and/or machine-readable instructions to enable the processor 304 to communicate with various input and/or output devices, such as a keyboard, a mouse, a display, another apparatus, electronic device, computing device, etc., through which a user may input instructions and/or data into the apparatus 302.

In some examples, the communication interface 324 may enable the apparatus 302 to communicate with a resource instance 320 or resource instances 320. For instance, a resources instance 320 may be an external device (e.g., computing device, server, etc.) in some examples. The apparatus 302 may be linked and/or coupled to the resource instance(s) 320 in some examples. For instance, the apparatus 302 may communicate with the resource instance(s) 320 using wired and/or wireless connection(s). In some examples, the apparatus 302 may communicate with the resource instance(s) 320 via a network or networks (e.g., LAN, WAN, the Internet, cellular network, LTE network, etc.). The network(s) may be included in the network 326 or may be separate from the network 326. In some examples, a resource instance 320 or resources instances 320 may be included in the apparatus 302. In some examples, a resource instance(s) 320 may be included in the apparatus 302 and a resource instance(s) 320 may be external device(s) or may be included in external device(s).

In some examples, the memory 306 of the apparatus 302 may store director instructions 314, project data 308, and/or predicted data 310. In some examples, the director instructions 314 may include training instructions 312, first machine learning model data 316, and/or selector instructions 318.

In some examples, the apparatus 302 may receive and store information (e.g., project request(s) and/or project data 308) corresponding to a remote client device 328 or remote client devices 328. For example, the processor 304 may receive a set of project requests indicating a corresponding set of data sizes. The data sizes may be stored as project data 308. In some examples, a project request may indicate a model type, a data size, a protocol, a data format, and/or a request time corresponding to the project. The model type, data size, protocol, data format, and/or request time for each project request may be stored as project data 308 in some examples.

In some examples, the processor 304 may determine a set of processing workloads and processor types utilized during execution of a set of projects corresponding to the set of project requests. For example, when a project is executed, the processor 304 may execute the director instructions 314 to select and/or direct a resource instance 320 or resource instances 320 to execute the project. In some examples, the processor 304 may execute the director instructions 314 to select a processor type or processor types for the project. For instance, the processor 304 may look up a processor type or types in a look-up table when the first machine learning model is not trained and/or when a confidence value corresponding to a prediction is low. In some examples, the apparatus 302 may send an instruction to the resource instance(s) 320 to execute the project and/or may route data for the project to the resource instance(s) 320. In some examples, the instruction may indicate a selected processor type(s) (e.g., CPU, GPU, and/or TPU) to execute the project. In some examples, the processor type(s) may be stored as project data 308. Accordingly, the processor 304 may determine a set of processor types utilized during execution of a set of projects corresponding to a set of project requests.

In some examples, a resource instance 320 may include CPU(s) 322, GPU(s) 324, TPU(s) 330, RAM 332, and/or NVM 334. In some examples, different resource instances 320 may include different numbers of CPU(s) 322, GPU(s) 324, and/or TPU(s) 330. In some examples, different resource instances 320 may include different amounts of RAM 332 and/or NVM 334. In some examples, a resource instance 320 may omit CPU(s) 322, GPU(s) 324, TPU(s) 330, RAM 332, and/or NVM 334.

When the apparatus 302 directs a resource instance 320 to load a machine learning model and/or to execute a project, the resource instance 320 may load a machine learning model of a set of machine learning models 336 from NVM 334 to RAM 332 in a case that the machine learning model is not already loaded. In some examples, the apparatus 302 may monitor a processing workload during execution of the project and/or may receive a processing workload indicator from a resource instance 320. The processing workload may be stored as project data 308. Accordingly, the processor 304 may determine a set of processing workloads utilized during execution of a set of projects corresponding to a set of project requests.

In some examples, the processor 304 may execute the training instructions 312 to train a first machine learning model based on the set of data sizes, the set of processing workloads, and the set of processor types. The first machine learning model may be stored as first machine learning model data 316. Training the first machine learning model may include adjusting weights of the first machine learning model. For example, the weights may be stored in the first machine learning model data 316. The first machine learning model may be separate from the set of machine learning models 336. For example, the first machine learning model may operate as a director mechanism or as part of a director mechanism to enable selection of a machine learning model from the set of machine learning models 336. In some examples, the set of machine learning models 336 may be pre-trained and/or the first machine learning model may not be pre-trained.

In some examples, the processor 304 may execute the director instructions to predict a processing workload and a processor type based on the first machine learning model. For instance, when the first machine learning model is trained, the processor 304 may utilize the first machine learning model to predict the processing workload and/or processor type for an anticipated future project request (e.g., before receipt of the future project request). The predicted processing workload and/or processor type may be stored as predicted data 310. In some examples, the training instructions 312 may be executed periodically to update the training of the first machine learning model. In some examples, the training may be updated based on whether anticipated project request(s) were actually received and/or based on whether the predicted processor workload(s) were accurate.

In some examples, the processor 304 may execute the director instructions 314 to load a machine learning model from the set of machine learning models 336 based on the processing workload (e.g., the predicted processing workload). For instance, if the predicted processing workload indicates that the processing workload will increase due to an anticipated project request, the processor 204 may load a machine learning model of the set of machine learning models 336. For example, the processing workload may increase from a state in which no project is being executed, or from a state in which a project or projects (e.g., other project(s)) are currently being executed. For instance, a machine learning model or machine learning models may already be loaded into RAM for execution of a project or projects. The director instructions 314 may be utilized to load another machine learning model from NVM into RAM for execution of an anticipated project request or project requests. In some examples, the processor 304 may execute the selector instructions 318 to select a resource instance 320 based on the processing workload (e.g., the predicted processing workload) and the processor type (e.g., the predicted processor type). For instance, the processor 304 may select a resource instance 320 with the predicted processor type and with available processing resources that are greater than the predicted processing workload. In some examples, the processor 304 may send a message to a resource instance 320 (e.g., the selected resource instance 320) to load the machine learning model from NVM 334 into RAM 332.

While FIG. 3 illustrates some examples of an architecture in which some of the techniques described herein may be implemented, other architectures may be utilized. In some examples, client devices 328 may send project requests that request a service and/or API for machine learning models 336. The apparatus 302 may receive the project requests. The processor 304 may execute the director instructions 314 to implement a director mechanism. The project requests may be provided to the director mechanism. The director mechanism may predict resource instances 320 and/or processing resources to be used for projects and for triggering target resource instances 320. In some examples, the resource instances 320 may be containers, virtual machines, and/or physical machines. In some examples, a resource instance 320 may include NVM 334 and/or heterogeneous processors (e.g., CPUs 322, GPUs 324 324, and/or TPUs 330). The processors (e.g., CPUs 322, GPUs 324, and/or TPUs 330) may be capable of processing machine learning model processing workloads. The NVM 334 may store the machine learning models 336 that may be loaded for processing.

In some examples, the client device 328 may be a computing device (e.g. smart phone, tablet, computer, laptop, etc.) that is capable of sending requests via a communication protocol, such as REST, SOAP or gRPC. The client device 328 may communicate via a local or network connection.

The director mechanism may receive project requests and may analyze processing workload based on the project requests. In some examples, the director mechanism may predict a processor type to perform the processing workload based on execution time, response time, and/or availability. The director mechanism may trigger processing for services to perform project(s). In some examples, the director mechanism may include a first machine learning model (e.g., predictive model(s)) and a selector.

In some examples, the first machine learning model may include a model or models. For example, the model(s) may be implemented using machine learning models such as linear regressions and/or recurrent neural networks. In some examples, the first machine learning model may be trained at run time. For instance, the first machine learning model may start operation without training data and/or may use runtime data for training and prediction. In some examples, the first machine learning model may be trained with information from the project requests, such as model type (e.g., image classification model A, object detection model, etc.), data size (e.g., data size in bytes), protocol (e.g., REST), and/or data format (e.g., JSON, protobuf, etc.). For instance, data size may account for different amounts of data, such as larger or smaller images. Upon a cold start, for example, the information from the project requests may be stored with processor workload, model type, and processor type as project data 308.

An example of information that may be stored as project data 308 is illustrated in Table (1). The data sizes are shown in terms of megabytes (MB) in Table (1).

TABLE 1

| | Data | | Data | | Processing | Processor |
|---|---|---|---|---|---|---|
| Model Type | Size | Protocol | Format | . . . | Workload | Type |
| Image | 10 MB | REST | JSON | . . . | 10% | GPU |
| Classifica- | | | | | | |
| tion A | | | | | | |
| Image | 100 MB | REST | JSON | . . . | 20% | TPU |
| Classifica- | | | | | | |
| tion B | | | | | | |
| Object | 2 MB | gRPC | protobuf | . . . | 15% | CPU |
| Detection | | | | | | |
| . . . | . . . | . . . | . . . | . . . | . . . | . . . |

When the first machine learning model is trained, the first machine learning model may predict processing workload and/or processor type. In some examples, the prediction of the first machine learning model may be used with heuristics (e.g., predefined heuristics) that may guide the selection of the resource instance 320 to run the processing workload. In some examples, the heuristics may be in the form of an if-then rule or rules. The if-then rule(s) may provide flexibility in terms of customizing workflows. In some examples, the heuristics (e.g., if-then rules) may be included in the selector instructions 318. The heuristics may be implemented in accordance with a specific application and/or scenario. Some examples of the heuristics follow: IF confidence value >0.8, THEN use model prediction. IF confidence value >0.8 AND processor type==GPU AND model type utilizes 10 gigabytes (GB), THEN execute in resource instance with GPU and RAM≥10 GB. IF confidence value≥0.9 AND processing workload >70%, THEN execute in resource instance with TPU 330. IF confidence value <0.7 THEN use look-up table. Other heuristics may be utilized.

When the first machine learning model prediction has reached a confidence threshold (which may be predetermined and/or specified by a user), the first machine learning model may trigger the execution flow, which may load the machine learning model from NVM 334 and dispatch the execution to the selected resource instance 320. For example, the processor 304 may execute the director instructions 314 to send data to the selected resource instance 320, to receive a response, to store project request information and execution information as project data 308 and/or to send a response to a client device 328 that requested the project. In the case of cold start, in some examples, the director mechanism may have information regarding the services and corresponding initial parameters to provide a routing mechanism.

In some examples, the NVM 334 may enable proper functioning by providing a relatively large amount of rapid storage, which may be byte addressable and/or addressable through network storage. For example, having the machine learning models 336 stored in a pool of NVM 334 may allow the director mechanism to send instructions to load (e.g., copy) machine learning models 336 to target addressable space for processing resources with reduced delay.

In some examples, the machine learning models 336 may be stored in any NVM 334 pool and/or may be accessed through Remote Direct Memory Access (RDMA) protocols for NVM 334. This approach may have network delay, though no copy to locally addressable memory may be utilized. With this approach, the machine learning models 336 may not be replicated in different NVM 334 devices, since the machine learning models 336 may be directly accessed through a network, by pointing to the resource instance 320 that includes the selected machine learning model.

An example of a cold start scenario is given as follows: The client device 328 may send a project request via REST to a service API, requesting an image classification service for a given image. The director mechanism may receive the project request from the client device 328. Because the first machine learning model is not yet trained, the director mechanism may looks for service information in a look-up table, which may specify the service (e.g., image classification service) and initial operating parameters (e.g., memory amount and GPU 324 processor type). The director mechanism may trigger the execution by a selected resource instance 320. For instance, the director mechanism may send the data to a resource instance 320 that can offer better performance for the project in comparison with other resource instances 320. The director mechanism may also coordinate machine learning model loading from the NVM 334 (which may be through a network). The resource instance 320 (which can interact with the NVM 334) may load the machine learning model for a processor. For example, if the processor type is a GPU 324, the machine learning model may be loaded to GPU 324 memory. The processor may execute inference procedures and may send a response back to the director mechanism. The director mechanism may store project request information with processing workload (and/or execution time) and the processor type as project data 308. The director mechanism may send a response (e.g., processing results) to the client device 328.

An example of a trained first machine learning model scenario is given as follows: The client device 328 may send a project request via REST to a service API, requesting an image classification service for a given image. The director mechanism may receive the project request from the client device 328. Because the first machine learning model is now trained, the director mechanism sends the project request information to the first machine learning model and obtains the predicted processor usage and processor type. The director mechanism may evaluate the prediction with a confidence value. Heuristics (which may be customized by a user in some examples) may be utilized to decide whether or not to use this prediction or to use information from the look-up table. The director mechanism may trigger the execution by a selected resource instance 320. For instance, the director mechanism may send the data to a resource instance 320 that can offer better performance for the project in comparison with other resource instances 320. The director mechanism may also coordinate machine learning model loading from the NVM 334 (which may be through a network). The resource instance 320 (which can interact with the NVM 334) may load the machine learning model for a processor. For example, if the processor type is a GPU 324, the machine learning model may be loaded to GPU 324 memory. The processor may execute inference procedures and may send a response back to the director mechanism. The director mechanism may store project request information with processing workload (and/or execution time) and the processor type as project data 308. The director mechanism may send a response (e.g., processing results) to the client device 328.

Some of the elements described in the scenarios may be implemented in different ways. For example, the look-up table may be manually filled or be filled after executing a given machine learning model in example scenarios. The first machine learning model used to decide the processor workload and processor type to be used may be one of the above-mentioned models or may be based on reinforcement learning approaches, where the cost or reward may be specified by a measure, such as response time and/or energy consumption. The heuristics for using the model may or may not be manually specified. The heuristics may be rules regarding whether to utilize the prediction or not based on a confidence value.

In some examples, the director instructions 314 may include a preprocessing engine (which may include NVM 334 programming), which may provide instructions to point to the machine learning models 336 stored in the NVM 334, to maintain the program request information for analysis, to manage the project requests, and/or to perform managing project request flows and predictions. In some examples, when processing is completed for a project, the processor (e.g., CPU 322, GPU 324, and/or TPU 330) may flush the data to the NVM 334 and enter a stand-by mode. The processor (e.g., CPU 322, GPU 324, and/or TPU 330) may await a trigger for further processing. Some examples of the techniques described herein may accordingly provide resource savings. The resource saving may enable other resource investments by leveraging the capability of power consumption savings and hardware consumption savings.

Some benefits of some examples of the techniques described herein are given as follows. Some examples may reduce the costs of machine learning services, since high resource consumption by processors may correspond to high costs. Some examples may save energy in cases where complex models are used (e.g., deep neural networks), since some models may use a large amount of GPU memory and each GPU can consume up to 250 Watts (W).

Some examples may increase service availability, because some customers may utilize a large processor infrastructure to keep enterprise applications running. Some examples may improve service speed, because it takes less time to load data from NVM than to consume a non-cached application. Some examples may help to reduce processor usage without losing performance. Some examples may reduce energy consumption in comparison to other approaches that perpetually maintain processor activity. Some examples may reduce memory usage in comparison with approaches that perpetually maintain models in memory. Some examples may be utilized in cloud implementations. Some examples may be utilized in local implementations (e.g., micro data centers). Some examples offer an architecture that balances processor workload by directing API requests and reducing the conflict between performance and cost. This is in contrast to other approaches that offer processors as a commodity, which can increase costs. Some examples enable flexible specification of heuristics, which may enable compatibility with a variety of applications. Fuzzy heuristics may be utilized in some examples.

In some examples, the apparatus 302 may create a recommendation based on prediction (e.g., processing workload, processor type, etc.) and/or received information. For instance, the processor 304 may execute the director instructions 314 to create a recommendation based on prediction and/or based on a project request (e.g., project request(s) and/or information associated with the project request(s)). The recommendation may be sent to a client device 328 or client devices 328 to change a project request. In some examples, the recommendation may indicate that different project requests (e.g., different service parameters) may be beneficial. For instance, the apparatus 302 may send a recommendation to a client device 328 to recommend changing a protocol to gRPC from REST. For instance, a project that utilizes gRPC may offer better performance than a similar project that utilizes REST.

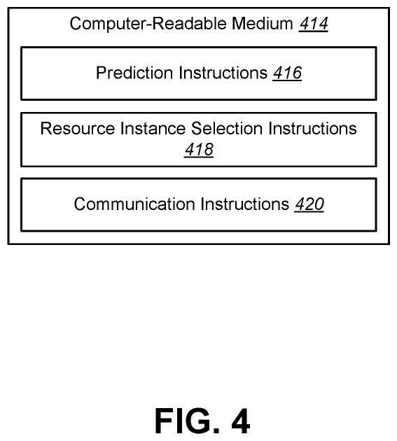

FIG. 4 is a block diagram illustrating an example of a computer-readable medium 414 for predicting processing workloads. The computer-readable medium is a non-transitory, tangible computer-readable medium 414. The computer-readable medium 414 may be, for example, RAM, EEPROM, a storage device, an optical disc, and the like. In some examples, the computer-readable medium 414 may be volatile and/or non-volatile memory, such as DRAM, EEPROM, MRAM, PCRAM, memristor, flash memory, and the like. In some implementations, the memory 306 described in connection with FIG. 3 may be an example of the computer-readable medium 414 described in connection with FIG. 4.

The computer-readable medium 414 may include code (e.g., data and/or instructions). For example, the computer-readable medium 414 may include prediction instructions 416, resource instance selection instructions 418, and/or communication instructions 420.

The prediction instructions 416 include code to cause a processor to determine a predicted processing workload and a predicted processor type. This may be accomplished as described in connection with FIG. 1, FIG. 2, and/or FIG. 3.

The resource instance selection instructions 418 may include code to cause a processor to select a resource instance based on the predicted processing workload and the predicted processor type. This may be accomplished as described in connection with FIG. 1, FIG. 2, and/or FIG. 3.

The communication instructions 420 may include code to cause a processor to send a message to the resource instance to load a machine learning model from NVM into RAM. This may be accomplished as described in connection with FIG. 1, FIG. 2, and/or FIG. 3.

In some examples, other kinds of machine learning models may be trained and utilized. For example, classification models (e.g., supervised classifier models), artificial neural networks, decision trees, random forests, support vector machines, Gaussian classifiers, k-nearest neighbors (KNN), including combinations thereof, etc., may be utilized.

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A method, comprising:
predicting a processing workload for a set of machine learning models; and
loading a machine learning model of the set of machine learning models from non-volatile memory based on the predicted processing workload.

2. The method of claim 1, further comprising predicting a processor type corresponding to the processing workload.

3. The method of claim 2, wherein the processor type is predicted from a group of processor types comprising a central processing unit (CPU), graphics processing unit (GPU), and tensor processing unit (TPU).

4. The method of claim 2, wherein the machine learning model is loaded into random access memory (RAM) of a resource instance with the predicted processor type and with available processing resources that are greater than the predicted processing workload.

5. The method of claim 1, wherein predicting the processing workload is performed by a first machine learning model.

6. The method of claim 5, wherein the first machine learning model is trained with a set of data sizes corresponding to a set of projects.

7. The method of claim 5, wherein the first machine learning model is trained with a set of processing workloads and a set of processor types corresponding to a set of projects.

8. The method of claim 5, wherein the first machine learning model is trained with a set of model types, a set of protocols, a set of data formats, or a set of information that characterizes workloads corresponding to a set of projects.

9. The method of claim 1, further comprising determining a confidence value that indicates a likelihood that the processing workload prediction is correct.

10. The method of claim 9, further comprising loading the machine learning model to a resource instance with a first processor type in a case that the processing workload is greater than a workload threshold and the confidence value is greater than or equal to a confidence threshold.

11. An apparatus, comprising:
a memory; and
a processor coupled to the memory, wherein the processor is to:
determine a set of processing workloads and processor types utilized during execution of a set of projects corresponding to a set of project requests indicating a corresponding set of data sizes;
train a first machine learning model based on the set of data sizes, the set of processing workloads, and the set of processor types; and
predict a processing workload and a processor type based on the first machine learning model.

12. The apparatus of claim 11, wherein the processor is to send a recommendation to a client device to change a project request.

13. The apparatus of claim 11, wherein the processor is to:
select a resource instance based on the processing workload and the processor type; and
send a message to a resource instance to load the machine learning model from non-volatile memory into random access memory.

14. A non-transitory tangible computer-readable medium storing executable code, comprising:
code to cause a processor to determine a predicted processing workload and a predicted processor type; and
code to cause the processor to select a resource instance based on the predicted processing workload and the predicted processor type.

15. The computer-readable medium of claim 14, further comprising code to cause the processor to send a message to the resource instance to load a machine learning model from non-volatile memory into random access memory.
